(19) United States
(12) Patent Application Publication
(10) Pub. No.: US 2014/0278983 A1
(43) Pub. Date: Sep. 18, 2014

(54) USING ENTITY REPOSITORY TO ENHANCE ADVERTISEMENT DISPLAY

(71) Applicant: MICROSOFT CORPORATION, Redmond, WA (US)

(72) Inventors: Dirk H. REINSHAGEN, Bellevue, WA (US); David C. KU, Bellevue, WA (US); Aravind BALA, Redmond, WA (US); Eric M. BOYD, Clyde Hill, WA (US); Ramu MOVVA, Redmond, WA (US); Anand SAMPATHKUMARAN, Redmond, WA (US); Fnu SIDHARTHA, Bellevue, WA (US); Chad P. WALTERS, San Francisco, CA (US)

(73) Assignee: MICROSOFT CORPORATION, Redmond, WA (US)

(21) Appl. No.: 13/835,410

(22) Filed: Mar. 15, 2013

(51) Int. Cl. G06Q 30/02

(52) U.S. Cl. CPC G06Q 30/0256; G06Q 30/0275
USPC 705/14.54; 705/14.71

(57) ABSTRACT

In various embodiments, systems and methods are provided for facilitating enhanced advertisement display. In embodiments, an indication of an entity preference and a corresponding entity bid in association with an advertisement are received. Thereafter, the entity preference and the corresponding entity bid associated with the advertisement are provided for use in an advertisement auction when at least one search result for a query is associated with the entity preference. In such a case, the entity bid is used to participate in the advertisement auction.

### BACKGROUND

Advertisements are commonly displayed in association with web content, such as a set of search results or a webpage. Selecting an advertisement for display in association with the web content is generally based on a user search query available at the time of advertisement delivery. In this regard, an advertisement or advertisements selected for display are generally based on a keyword within the query matching a keyword within an advertiser's list of keywords. Such advertisement selection is oftentimes based on the keywords designated by the advertisers that the advertisers believe will be beneficial. Further, the displayed advertisements are generally limited in scope to the content provided by the advertiser.

### SUMMARY

This Summary is provided to introduce a selection of concepts in a simplified form that are further described below in the Detailed Description. This Summary is not intended to identify key features or essential features of the claimed subject matter, nor is it intended to be used as an aid, in isolation, in determining the scope of the claimed subject matter.

In various embodiments, systems and methods are provided for facilitating use of an entity repository to enhance advertisement display. In this regard, an entity repository containing structured data pertaining to various entities can be referenced and utilized to enhance advertisements and improve advertisement selection. In embodiments, advertisements and/or incoming queries can be tagged or otherwise associated with an entity identifier to facilitate enhanced advertisements and/or enhanced advertisement selection. Using the entity identifiers, supplemental data can be referenced in the entity repository and used to enhance an advertisement provided by an advertiser.

### BRIEF DESCRIPTION OF THE DRAWINGS

The invention is described in detail below with reference to the attached drawing figures, wherein:

FIG. 1 is a block diagram of an exemplary computing device suitable for implementing embodiments of the present invention;

FIG. 2 is a schematic diagram of an exemplary advertisement environment, in accordance with embodiments of the present invention;

FIG. 3 illustrates an exemplary method for enhancing advertisements, in accordance with an embodiment of the present invention;

FIG. 4 illustrates an exemplary method for enhancing advertisement selection using a query-entity identifier(s), in accordance with an embodiment of the present invention;

FIG. 5 illustrates a first exemplary method of enhancing advertisement selection using an entity preference, according to embodiments of the present invention;

FIG. 6 illustrates a second exemplary method of enhancing advertisement selection using an entity preference, according to embodiments of the present invention; and

FIG. 7 illustrates a third exemplary method of enhancing advertisement selection using an entity preference, according to embodiments of the present invention.

### DETAILED DESCRIPTION

In various embodiments, systems and methods are provided for facilitating use of an entity repository to enhance advertisement display. In this regard, an entity repository containing structured data pertaining to various entities can be referenced and utilized to enhance advertisements and improve advertisement selection. In embodiments, advertisements and/or incoming queries can be tagged or otherwise associated with an entity identifier to facilitate enhanced advertisements and/or enhanced advertisement selection. Using the entity identifiers, supplemental data can be referenced in the entity repository and used to enhance an advertisement provided by an advertiser.

Embodiments of the invention described herein include one or more computer-storage media storing computer-useable instructions that, when executed by a computing device, perform a method for facilitating enhanced advertisement display. The method includes receiving an indication of an entity preference and a corresponding entity bid in association with an advertisement. Thereafter, the entity preference and the corresponding entity bid associated with the advertisement are provided for use in an advertisement auction, wherein when at least one search result for a query is associated with the entity preference, the entity bid is used to participate in the advertisement auction.

In a second illustrative embodiment, one or more computer-storage media storing computer-useable instructions that, when executed by a computing device, perform a method for facilitating enhanced advertisement display. The method includes recognizing an entity identifier uniquely identifying an entity associated with an advertisement selected for presentation in response to a received search query. The entity identifier is used to identify supplemental data within an entity repository that is associated with the entity identifier. An enhanced advertisement that includes the advertisement and the supplemental data is provided, for example, to a user device.

In a third illustrative embodiment, a system for facilitating enhanced advertisement display is provided. The system includes a core advertisement index including a plurality of core advertisements available for display based on one or more corresponding keywords for each core advertisement. The system also includes a plurality of vertical advertisement indices, wherein each vertical advertisement index includes a plurality of item advertisements associated with a vertical segment that are available for display based on one or more corresponding filters for each item advertisement. The system further includes an advertisement selecting component that obtains core advertisements relevant to a search query and item advertisements relevant to a search query and utilizes keyword bids associated with the core advertisements and autotarget bids associated with the item advertisements to select one or more advertisements from among the obtained core advertisements and index advertisements to present in response to the search query.

Having briefly described an overview of embodiments of the present invention, an exemplary operating environment in which embodiments of the present invention may be implemented is described below in order to provide a general context for various aspects of the present invention. Referring to the figures in general and initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one or combination of components illustrated.

Embodiments of the invention may be described in the general context of computer code or machine-useable instructions, including computer-useable or computer-executable instructions such as program modules, being executed by a computer or other machine, such as a personal data assistant or other handheld device. Generally, program modules including routines, programs, objects, components, data structures, and the like, refer to code that performs particular tasks or implements particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network.

With continued reference to FIG. 1, the computing device 100 includes a bus 110 that directly or indirectly couples the following devices: a memory 112, one or more processors 114, one or more presentation components 116, input/output (I/O) ports 118, I/O components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media may be any available media that is accessible by the computing device 100 and includes both volatile and nonvolatile media, removable and non-removable media. Computer-readable media comprises computer storage media and communication media. Computer storage media includes volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. As defined herein, computer storage media does not include communication media. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative components include a microphone, joystick, game pad, satellite dish, scanner, printer, wireless device, and the like.

### Enhanced Advertisement System

Referring now to FIG. 2, a block diagram is provided illustrating an exemplary advertising system 200 in which embodiments of the present invention may be employed. Generally, the advertising system 200 illustrates an environment in which an entity knowledge base or entity repository can facilitate advertisement display. In this regard, an entity knowledge base can be used to generate enhanced advertisements, enhance advertisement selection, and/or enhance advertisement ranking.

Among other components not shown, the advertisement system 200 generally includes an advertiser device 202, an advertisement manager 204, an entity repository 206, an advertisement delivery service 208, a search engine 210, and a user device 212. Although not illustrated, any number of components can be in communication with one another via a network or networks. A network may include, without limitation, one or more local area networks (LANs) and/or wide area networks (WANs). By way of example only, the advertiser device 202 and/or the user device 212 can be in communication with the one or more other components via the Internet. Such networking environments are commonplace in offices, enterprise-wide computer networks, intranets and the Internet. Accordingly, the network is not further described herein.

It should be understood that any number of advertiser devices, advertisement managers, entity repositories, advertisement delivery services, search engines, and user devices may be employed in the advertisement system 200 within the scope of embodiments of the present invention. Each may comprise a single device/interface or multiple devices/interfaces cooperating in a distributed environment. For instance, the advertisement delivery service 208 may comprise multiple devices and/or modules arranged in a distributed environment that collectively provide the functionality of the advertisement delivery service 208 described herein. Additionally, other components/modules not shown also may be included within the advertisement system 200.

It will be understood by those of ordinary skill in the art that the components/modules illustrated in FIG. 2 are exemplary in nature and in number and should not be construed as limiting. Any number of components/modules may be employed to achieve the desired functionality within the scope of embodiments hereof. Further, components/modules may be located on any number of computing devices. By way of example only, the search engine 210 might be provided as a single server (as shown) or a cluster of servers.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more components may be carried out by hardware, firmware, and/or software. For instance, various functions may be carried out by a processor executing instructions stored in memory. The components/devices of FIG. 2 may be or include any type of computing device(s), such as the computing device 100 described with reference to FIG. 1, for example.

In operation, the advertiser device 202 can be any computing device capable of receiving and providing advertising data. An advertiser may be an individual or a representative of a company, an association, an organization, an institution, etc. that facilitates submission of an advertisement, or data associated therewith, for use in electronic display. An advertiser can input advertising data into advertiser device 202 in any number of manners, for example, using an advertising user interface that enables an advertiser to input, provide, or select advertising data.

Advertising data may include various types of data associated with one or more advertisements that an advertiser would like displayed. By way of example, and not limitation, advertising data may include advertisements, advertisement preferences, advertisements bids, or the like. An advertisement refers to a communication used to encourage an audience to continue or take a new action (e.g., purchase an item, view a website, view an item, or the like). In this way, an advertisement can be information, such as text and/or an image(s), that can be electronically displayed to promote a product, service, or other item. Although advertisements are generally referred to herein as material that can be electronically displayed, embodiments of the present invention are not intended to be limited in scope. For example, embodiments of the present invention can encompass audio advertisements that can be audibly presented to a user via the user device 212.

As used herein, an advertisement might be a core advertisement or an item advertisement. A core advertisement refers to a traditional Internet advertisement. A core advertisement may include, for example, a source, a URL, and a description. Generally, a core advertisement is an advertisement pertaining to or directed to a particular business, organization, institution, association, merchant, retailer, or the like. For example, a core advertisement might be directed to or contain an offer, a discount, an announcement, information, etc. for a particular website, provider, or other source. In this way, a core advertisement is generally related to an offer or promotion for multiple items (e.g., products and/or services) associated with the provider. As described in more detail below, a core advertisement is generally associated with a keyword or keywords such that selection of the core advertisement is based, at least in part, on usage of the keyword(s) in a search query.

An item advertisement refers to an advertisement for a particular item or set of items. An item advertisement may include, for example, a source, a URL, a description of the item(s); an image of the item(s); a cost of the item(s), a stock-keeping unit (SKU) for the item(s), or other information, for example, that might be included in a catalogue or like material. Generally, an item advertisement is an advertisement pertaining to or directed to a particular item or particular group of items offered by a source (e.g., business, organization, institution, association, merchant, retailer, or the like). For example, an item advertisement might be directed to or contain an offer, a discount, an announcement, information, etc. for a particular product or service offered by a website, provider, or other source. In this way, an item advertisement is generally related to an offer or promotion for a single item (e.g., products or services) associated with the provider. As described in more detail below, an item advertisement is generally associated with an autotarget or autotargets such that selection of the item advertisement is based, at least in part, on analysis of the autotarget.

An advertisement preference refers to an advertiser's preference for which an advertisement is desired to be displayed. As such, an advertisement preference can be provided by an advertiser, for example, via the advertiser device 202. An advertisement preference may be a keyword preference, an autotarget preference, or an entity preference. A keyword preference refers to a term or phrase for which the advertiser would like an advertisement displayed. In this way, when a particular term or phrase is present in a search query or web content, the advertiser would like a corresponding advertisement to be displayed. As can be appreciated, a particular advertisement may be associated with any number of keywords. Further, a set of keywords can be associated with a group of advertisements. An autotarget preference refers to one or more item filters that are used to filter items for relevance and/or display. As such, an autotarget may be a multi-faceted filter. An item filter may be any filter that can be used to filter items for relevance such as, a product type, a product category, a brand, etc. In this regard, an advertiser might provide (e.g., select, input, or otherwise indicate) a product type and/or a brand as an autotarget for a particular advertisement or set of advertisements. An entity preference refers to an entity for which the advertiser would like an advertisement to be displayed when the entity is associated with search results. In this way, the user can input, provide, or select an entity or entity identifier that, when provided in association with a search result, the advertiser would like a particular advertisement displayed or any advertisement from the advertiser (or associated with a particular advertisement campaign) displayed. Such an advertisement could be a core advertisement or an item advertisement.

An advertisement bid refers to a monetary amount or value of which the advertiser will pay or provide for display and/or selection (i.e., click) of a corresponding advertisement. An advertisement bid can be a keyword bid, an autotarget bid, or an entity bid. A keyword bid refers to a bid associated with display and/or selection of an advertisement associated with a particular keyword or set of keywords. As can be appreciated, a keyword bid can be specific to an advertisement, a set of advertisements, a keyword, a set of keywords, or a combination thereof. An autotarget bid refers to a bid associated with display and/or selection of an advertisement associated with a particular autotarget (i.e., filter(s)). In this regard, any items falling within the scope of a particular autotarget (e.g., brand) will correspond with an autotarget bid associated with that autotarget. By way of example only, assume an autotarget bid of $1.00 is associated with an autotarget identifying a Brand A. The $1.00 bid will be associated with each returned item that is Brand A. An entity bid refers to bid associated with display and/or selection of an advertisement when the entity is associated with a search result(s).

Any such advertising data can be input by an advertiser(s) and, thereafter, the advertiser can provide an indication to submit or transmit the advertising data for use in advertisement selection and/or display. A graphical user interface provided at the advertiser device 202 can be used to facilitate entry of such data. In some cases, a data feed can be used to load advertising data, or a portion thereof. For example, a data feed can be used to load item advertisements or information, such as a product or service catalogue, or like material.

The advertisement manager 204 can receive and manage advertising data. In this regard, upon receiving advertising data from an advertiser device, the advertisement manager 204 can identify the advertising data and determine utilization of such received data. Although the advertisement manager 204 is illustrated as separate from the entity repository 206 and the advertisement delivery service 208, such a component, or capabilities thereof, can be integrated with or performed by the entity repository 206 and/or the advertisement delivery service 208 (e.g., the advertisement center 220 and/or the feed management center 226).

For an advertisement received at the advertisement manager 204, the advertisement manager 204 can reference or communicate with the entity repository 206 to obtain an entity identifier associated with the advertisement. An entity identifier refers to an identifier that uniquely identifies an entity provided in the entity repository 206. Accordingly, each entity within the entity repository has a unique entity identifier associated therewith. An entity identifier to be associated with an advertisement can be obtained in any number of ways. In one implementation, the advertisement manager 204 can provide an intent, subject matter, or other attribute of the advertisement to the entity repository 206. Thereafter, the entity repository 206 can lookup or determine an entity closely related or associated with the advertisement. Upon identifying such an entity, the entity identifier corresponding with the identified entity can be associated with the advertisement. In another implementation, the advertisement manager 204 can provide the advertisement to the entity repository 206. The entity repository 206 can then perform analysis of the advertisement, or data associated therewith, to identify an entity identifier to be associated with the advertisement.

Upon obtaining the entity identifier for the advertisement, the advertisement can be stamped, tagged, and/or otherwise associated with the entity identifier. As described more fully below, association of an advertisement with an entity identifier can enable enhanced advertisements, enhanced advertisement selection, and/or enhanced advertisement ranking The advertisement and corresponding entity identifier can be provided to the advertisement delivery service 208 by the advertisement manager 204 or the entity repository 206. In this way, the entity repository 206 might provide an entity identifier to the advertisement manager 204 for association with the advertisement and, thereafter, the advertisement manager 204 can provide the advertisement and/or entity identifier to the advertisement delivery service 208. Alternatively, the entity repository 206 might associate the entity identifier with the advertisement and provide the association to the advertisement delivery service 208.

The advertisement manager 204 can provide other advertising data, either directly or indirectly (e.g., via the entity repository 206) to the advertisement delivery service 208. For instance, any advertisements, advertisement preferences (e.g., keywords, autotargets, entities) or advertisement bids can be provided to the advertisement delivery service 208 for use in advertisement selection.

The entity repository 206 is a knowledge base or information repository that allows entity data to be collected, organized, shared, searched and/or utilized. Generally, an entity refers to a person, place, or thing (i.e., a noun). As described in more detail below, in embodiments, the entity repository 206 can be used in various manners to enhance advertisements, enhance advertisement selection, and/or enhance advertisement ranking In this regard, an entity repository can be used for improving both search results and advertisement results. In embodiments, the entity repository 206 includes various entities and data associated therewith. Each entity is associated with or corresponds to a particular entity identifier that uniquely indicates or identifies the entity. The entity data includes various types of structured data and, in embodiments, may pertain to various industry segments or verticals. Further, entity data associated with a particular entity may include indications of related entities and/or entity attributes (e.g., category or product type).

In embodiments, the entity repository 206 is a graph database or repository that is based on entities and mapped relationships or links between the entities. Generally, an entity repository can include semantic data objects, corresponding entity identifiers, a collection of entity data associated with the entity, and links representing relationship to other entities. By way of example only, a DVD of a movie can be a separate entity from the movie itself, but the two entities can be linked to one another, for instance, to link information regarding the director, cast, etc.

The entity repository 206 can be generated or updated in any number of ways, which are not intended to limit the scope of embodiments herein. In some embodiments, a webcrawler is used to extract data from structured information (e.g., phone numbers, addresses, prices, stocks, etc.) and/or unstructured information on webpages to create a structured database of the “nouns” of the Internet and the relationships between the entities. Such extracted data is associated with an entity or an entity identifier. The entities can be mapped or linked to one another to provide relationships among the entities. For example, an actor can be connected to a movie or other actors in the movie.

By way of example only, a webcrawler(s) can crawl a webpage, parse the webpage, and recognize a new object within the webpage. As such, a new entity can be generated and added to the entity repository. Other data on the webpage can be analyzed to assess characteristics, attributes, or other data associated with the new object. When another webpage is subsequently crawled that includes data associated with the generated entity, the webpage can be tagged and such data pertaining to the entity can be aggregated in association with the entity in the entity repository 206.

In some embodiments, the entity repository 206 can be populated with entity data provided by a user, such as an advertiser using the advertiser device 202. In this regard, an advertiser might input, provide, or select entity data (e.g., a news release, a rating, a description, or the like) via the advertiser device 202, which can be provided to the advertisement manager 204 to facilitate communication to the entity repository 206. Such entity data may be input in any number of ways, such as, for example, manual text input by the user, an indication of a URL, selection of a URL, selection of data, or the like.

Turning to the advertisement delivery service 208, the advertisement delivery service 208 is configured to deliver advertisements for display. Generally, the advertisement delivery service 208 is used to select and/or rank advertisements to be provided to a user device for display to a user. The advertisement delivery service 208 can be implemented in any number of different manners. It will be understood by those of ordinary skill in the art that the components/modules illustrated within the advertisement delivery service 208 are exemplary in nature and in number and should not be construed as limiting. Any number of components/modules may be employed to achieve the desired functionality within the scope of embodiments hereof. Further, components/modules may be located on any number of computing devices. By way of example only, the enhanced advertisement selector 224 might be provided as a single server (as shown) or a cluster of servers.

In one embodiment, the advertisement delivery service 208 includes an advertisement center 220, a core advertisement index 222, an enhanced advertisement selector 224, a feed management center 226, a first vertical pipeline 228, an nth vertical pipeline 230, a first vertical advertisement index 232, and an nth vertical advertisement index 234.

Initially, the advertisement center 220 and the feed management center 226 can receive advertising data provided by an advertiser via the advertiser device 202. The particular advertising data received by the advertisement center 220 and the feed management center 226 can be determined or recognized, for example, by the advertisement manager 204 and/or entity repository 206. As such, upon the advertisement manager 204 and/or entity repository 206 assessing received advertising data, the advertisement manager 204 and/or entity repository 206 can provide the advertisement center 220 and the feed management center 226 with the appropriate advertising data.

By way of example only, the feed management center 226 might be configured to receive item advertisements and corresponding entity identifiers while the advertisement center 220 is configured to receive other advertising data, such as, for instance, core advertisements and corresponding entity identifiers, advertising preferences (e.g., keywords, autotargets, entities), and advertising bids (e.g., keyword bids, autotarget bids, entity bids). In embodiments, the feed management center 226 can receive item advertisements by way of item feeds. In this regard, a data feed can be used for a source, such as a retailer, to provide a catalogue of items (e.g., products).

The advertisement center 220 and the feed management center 226 can, in some embodiments, be used to store advertising data. Such storage can allow an advertiser to update, modify, replace, add, or delete advertising data to maintain, for example, advertisements, advertisement preferences, and/or advertisement bids.

Although illustrated as two separate components, the advertisement center 220 and the feed management center 226 can be combined into one component or any other number of components. Further, any portion of the advertising data can go to either component. For example, any data related to item advertisements can be provided to the feed management center 226, and any data related to core advertisements can be provided to the advertisement center 220.

The advertisement center 220 can communicate advertising data to the core advertisement index 222 and/or the enhanced advertisement selector 224. The core advertisement index 222 is an index of advertisements and/or data associated therewith. Such data in the core advertisement index may include, for example, an advertisement title, an advertisement description, an advertisement URL or other source, or the like. The core advertisement index 222 can be created based on at least a portion of advertising data received by the advertisement center 220. As described in more detail below, the core advertisement index 222 can be used to select advertisements to be presented to a user, such as a user of user device 212.

Other advertising data, such as advertisement preferences and advertisement bids, can be provided by the advertisement center 220 to the core advertisement index 222 and/or the enhanced advertisement selector 224. In embodiments, at least some of the advertisement preferences and/or advertisement bids are communicated to the enhanced advertisement selector 224 for use in selecting an advertisement(s) to be presented to a user(s).

The feed management center 226 can communicate advertising data to the first vertical pipeline 228, the nth vertical pipeline 230, and/or any other vertical pipeline used to generate a vertical index. The feed management center 226 can determine which vertical pipeline(s) corresponds with the advertising data (e.g., item advertisements) and provide the advertising data thereto. In some cases, the determination of which vertical pipeline(s) corresponds with the advertising data can be made based on an analysis of the advertising data. In other cases, an identification of a vertical that corresponds with the advertising data can be provided, for example, by the advertiser (e.g., an advertiser indicator) or determined by another component (e.g., the advertisement manager 204).

Although the feed management center 226 is illustrated as a single component, as can be appreciated, any number of feed management centers can be utilized. For example, in some embodiments, each vertical pipeline may have a corresponding feed management center. In this regard, item advertisements associated with a particular vertical pipeline or index can be received at a corresponding feed management center.

The first vertical pipeline 228 and the nth vertical pipeline 230 are configured to generate the corresponding vertical advertisement index. In this regard, the first vertical pipeline 228 generates the first vertical advertisement index 232, and the nth vertical pipeline 230 generates the nth vertical advertisement index 234. The vertical pipelines 228 and 230 can be used to generate the corresponding vertical advertisement index in any number of manners. By way of example, the vertical pipeline can access data (e.g., receive or retrieve) from the feed management center 226 and use such advertising data to generate a corresponding index.

Each of the first vertical advertisement index 232 and the nth vertical advertisement index 234 are an advertisement index corresponding with a particular vertical. In this way, the first vertical advertisement index is an index of advertisements, or data associated therewith, associated with a particular vertical. Similarly, the nth vertical advertisement index is an index of advertisements, or data associated therewith, associated with another vertical. Such data in a vertical advertisement index may include, for example, vertical specific data related to an advertisement title, an advertisement description, an advertisement image, an advertisement URL or source, an entity identifier, a price, a SKU, or the like.

A vertical or industry vertical refers to specifically focused segments or classifications of online advertisement content that are searched. The vertical content area may be based on topicality, media type, genre of content, locality, or the like. Common verticals include web, news, images, video, audio, finance, travel, medical, legal, travel, shopping, a particular location, restaurants, entertainment, automotive, or the like. Using an appropriate vertical and vertical index, more relevant advertisements, such as item advertisements can be selected for display to a user, such as a user of user device 212.

The enhanced advertisement selector 224 is configured to facilitate advertisement selection. As such, the enhanced advertisement selector 224 can be used to select one or more advertisements (e.g., core advertisements and/or item advertisements) to be presented to a user.

In one embodiment, the enhanced advertisement selector 224 includes a query classifier 240 and an advertisement selector 242. It will be understood by those of ordinary skill in the art that the components/modules illustrated within the enhanced advertisement selector 224 are exemplary in nature and in number and should not be construed as limiting. Any number of components/modules may be employed to achieve the desired functionality within the scope of embodiments hereof. Further, components/modules may be located on any number of computing devices. By way of example only, the advertisement selector 242 might be provided as a single server (as shown) or a cluster of servers.

In operation, a user device 212 can provide a search query to the search engine 210. The user device 212 may provide a search query, for example, input by a user. The search engine 210 then provide the search query to the query classifier 240 to distribute the query to an appropriate set of advertisement indices. Potential advertisements can be obtained and analyzed by the advertisement selector 242 to identify a particular advertisement(s), an advertisement order, and/or an advertisement richness. Such data can then be provided to the search engine for presenting the resultant advertisements to the user device 212.

The query classifier 240 can receive a query. Such a query can be a user search query, or a portion thereof, input by a user at the user device 212, or a derivation thereof (e.g., annotated or supplemented). The query classifier 240 can then classify the query. In this regard, the query classifier 240 may analyze the query and determine intent of the query to classify the query. Such query classifications can correspond with available indices (e.g., vertical indices). As such, the query classifier 240 can associate a query with a particular index(s). For example, an incoming query might be classified as providing shopping intent (e.g., based on a brand being included in the query) and, as such, be associated with a shopping vertical index. Although illustrated as a single query classifier, in some embodiments, multiple query classifiers can be used to determine query intent and/or associate the query with a particular index(s). For example, a shopping query classifier may be configured to determine if the query includes any shopping intent, and a travel query classifier may be configured to determine if the query includes any travel intent.

Upon associating a query with one or more indices, the identified or selected index(s) can be used to obtain a set of potential advertisements that may be related to the query. In this regard, the query classifier 240 can distribute the query, or a portion thereof, to a relevant index(s) or utilize the corresponding index to obtain a set of potential advertisement results. In some embodiments, the query classifier 240 communicates the query, or portion thereof, to an appropriate index(s) based on the query classification. In other embodiments, the query classifier 240 uses the query, or portion thereof, to lookup or search an appropriate index(s) based on the query classification. In some cases, a core advertisement index, such as core advertisement index 222, is a default index selection. That is, in addition to any vertical index(s) identified as relevant or related to the query (e.g., based on query intent or classification), the core advertisement index is also searched for relevant advertisements.

As such, the query classifier 240 queries the identified or selected indices (e.g., information retrieval indices) using the search query, or portion thereof, for instance entered by a user, for instance. As can be appreciated, the queried index or indices can identify or determine relevant advertisements in any number of manners. For example, an advertisement within the core advertisement index might be identified as relevant when a term(s) or a phrase(s) in the search query matches advertising data (e.g., URL, advertisement description, advertisement keyword, etc.) associated with the advertisement. In this regard, an advertisement might be identified as relevant when a query term matches a term in the advertisement description, an advertisement keyword provided by the advertiser, or the like. In another example, an item advertisement within a vertical advertisement index might be identified as relevant when a term(s) or a phrase(s) in the search query matches or is related to advertising data (e.g., an advertisement category, such as a product category or type, a brand, an advertisement description) associated with the item advertisement. For example, assume that an incoming query is “coats.” In such a case, the shopping vertical advertisement index may be queried to find and return particular products that are indicated as falling within the “coat” product category. As previously described, the types of data within the core advertisement index and the various vertical advertisement indices may vary. For instance, in some cases, the core advertisement index may include the advertisement keywords provided by advertisers that are associated with the advertisements to facilitate identifying relevant advertisements, while the vertical advertisement indices may not include the autotargets provided by the advertisers (such autotargets might be accessed or stored in association with the enhanced advertisement selector 224).

The advertisement selector 242 can obtain one or more advertisements, or data associated therewith, that are identified as relevant to the query. In this way, the advertisement selector 242 obtains a pool of advertisements, or an advertisement pool, that are identified as relevant to the query. For instance, upon providing a query, or portion thereof, to one or more appropriate indices, advertisements, or data associated therewith, can be identified and returned to the advertisement selector 242. For instance, a core advertisement index and a vertical advertisement index can both be used to identify and return relevant advertisements (i.e., core advertisements and item advertisements) to the advertisement selector 242.

Upon obtaining advertisements deemed relevant to a search query, the advertisement selector 242 can analyze the potential advertisements to be presented as an advertisement result(s) and select the specific ad(s) to display. Further, in some embodiments, the advertisement selector 242 can identify an order or ranking in which to display the selected advertisements and/or an extent of richness in which present the selected ad(s). An extent of richness in which to present an advertisement may refer to a size of the advertisement, a color depth of the advertisement, whether to display an image, or any other prominence feature. The advertisement selection, ranking, and richness can be determined using any number of rules, algorithms, analysis, or processes. Factors that might be considered in any of advertisement selection, advertisement ranking, and/or advertisement richness may include, for example, relevance of the advertisement, budgeting, geotargeting, demotargeting, user preferences, or the like.

To determine relevance of the advertisement for use in advertisement selection, ranking, and/or richness, the relevance of the advertisement in relation to the search query can be assessed. To make such a relevance determination, any advertising data (e.g., advertising preferences or data describing the advertisement) associated with the advertisement may be compared to the search query. For example, for a core advertisement, an advertisement keyword provided by an advertiser or terms within the advertising description can be compared to the search query to identify whether a match or similarity exists. For an item advertisement, a product category or terms within the advertising description can be compared to the search query to identify whether a match or similarity exists. Advertisement relevance for advertisements may be compared to one another using a relevance score that can be determined, for example, by the advertisement selector 242 or the advertisement index that returned the advertisement.

Budgeting refers to analysis of advertising bids associated with advertisements for use in selecting, ranking, and/or determining richness. Budgeting rules may utilize advertising bids associated with advertisements, such as keyword bids, autotarget bids, and/or entity bids. For example, a keyword bid associated with a core advertisement deemed relevant can be used to analyze selection, ranking, and/or richness of the advertisement.

By way of another example, an autotarget bid associated with an item advertisement deemed relevant can be used to analyze selection, ranking, and/or richness of the advertisement. For instance, assume an advertiser indicates or defines an autotarget associated with a particular product category (e.g., “coats”) and a particular brand (e.g., Brand A) and provides an autotarget bid of $1.00 for display of any advertisement items falling within the scope of that autotarget. In such a case, when an item advertisement corresponding with the specified product category of “coats” and the brand of “Brand A” is deemed relevant, a $1.00 bid is applied in the advertisement auction and used for selecting, ranking, and/or displaying the item advertisement. As can be appreciated, multiple advertisements of an advertiser can fall within an autotarget (e.g., be of the same product category and/or brand) and, as such, compete with one another using the same autotarget bid.

In yet another example, an entity bid associated with an advertisement deemed relevant can be used to analyze selection, ranking, and/or richness of the advertisement. For instance, assume an advertiser indicates or identifies a particular entity (e.g., user selection or user input of an entity or entity identifier) and provides an entity bid of $1.00 for display of an advertisement when the entity is associated with a search result identified as related to the search query. In such a case, when a search result is to be presented that is associated with the entity, a $1.00 bid is applied in the advertisement auction for the advertisement and such a bid can be used for selecting, ranking, and/or displaying the advertisement. Such an implementation enables an advertiser to avoid selecting particular keywords or autotargets for an advertisement and, instead, provide an indication that whenever a particular entity is provided as a search result or associated with a search result, the advertiser would like their advertisement displayed (or one of their advertisements displayed).

Geotargeting refers to analysis of geography associated with the advertisement and/or user to determine selection, ranking, and/or richness of an advertisement. In this regard, an advertisement associated with a restaurant in City A might be more likely selected or have a higher ranking if the user resides or is currently located in City A. Geography associated with an advertisement may be detected from analysis of the advertisement or from input by an advertiser. For instance, when providing advertisements, an advertiser may indicate a preference that the advertisement be displayed when the search query indicates City A or the user is identified as associated with City A. Geography associated with the user can be detected in any manner, such as, for example, input by a user, a GPS or other location identifier associated with the user device, etc.

Demotargeting refers to analysis of demographics associated with the advertisement and/or user to determine selection, ranking, and/or richness of an advertisement. In this regard, an advertisement associated with a female might be more likely selected or have a higher ranking if the user is a female. A demographic(s) associated with an advertisement may be detected from analysis of the advertisement or from input by an advertiser. For instance, when providing advertisements, an advertiser may indicate a preference that the advertisement be displayed when the search query indicates a demographic or the user is identified as associated with a particular demographic(s). A demographic(s) associated with the user can be detected in any manner, such as, for example, input by a user, prediction or assumption based on previous selections or queries input by the user, or the like.

User preferences can be used to determine selection, ranking, and/or richness of an advertisement. In this regard, a user can input one or more preferences that can be used for selecting or displaying an advertisement. Alternatively or additionally, user preferences can be derived based on previous user actions, such as selected advertisements, selected search results, input queries, or the like.

The manner in which advertisement selector 242 utilizes and applies such factors of relevance, budgeting, geotargeting, demotargeting, and user preferences, among others, is not intended to limit the scope of the invention. Any number of such factors may be used in varying orders or weights. Other factors not described herein can also or alternatively be used in performing advertisement selection, advertisement ranking, and advertisement richness. Further, the same set of factors does not need to be utilized for each of advertisement selection, advertisement ranking, and advertisement richness. For example, in some cases, budgeting rules and relevance may be used for advertisement selection, while geotargeting and demotargeting rules may be used to perform advertisement ranking.

Upon identifying or selecting the advertisement or set of advertisements for display to the user and/or the manner in which to display the advertisement, the selected advertisements, and data associated therewith (e.g., display placement) can be returned to the user device 212. In some cases, the advertisements are initially returned to the search engine 210, for example, for incorporation into a search results page and then provided to the user device 212.

In addition to embodiments described above, the advertisement system 200 of FIG. 2 can facilitate additional various enhancements pertaining to advertisement display, as described in more detail below.

### Enhanced Advertisements

With continued reference to FIG. 2, the enhanced advertisement system 200 illustrated in FIG. 2 can be utilized to facilitate providing enhanced advertisements to users. An enhanced advertisement refers to an advertisement that has been enhanced with data that is supplemental to the advertisement, or advertisement data, provided by the advertiser. Enhanced data or annotations can be any type of data. By way of example and not limitation, enhanced data may describe or indicate rating information, award information, announcement information, hours of operation information, a business or product highlight information, certificate information, standards information, or the like.

Enhanced data, referring to the data added to an original advertisement provided by the user, can be obtained using the entity repository 206 of FIG. 2. In embodiments, to obtain such data, an entity identifier associated with an advertisement can be used to obtain enhanced data for the advertisement. As previously described, an advertisement, or data associated therewith, can correspond with an entity identifier. Such an entity identifier can be stored, for instance, along with the advertisement, or data thereof, in the corresponding index. In embodiments, entity identifiers can be stored along with core advertisements and/or item advertisements. In other embodiments, entity identifiers can be looked up for core advertisements and/or item advertisements.

Upon determining an advertisement for presentation (e.g., via the advertisement delivery service 208 of FIG. 2), the entity identifier associated therewith can be used to lookup enhanced data stored in the entity repository 206. By way of example, assume that an item advertisement for a particular shoe is selected for presentation and that shoe advertisement corresponds with an entity identifier 123. The entity identifier 123 can be used to look up other enhanced data in the entity repository 206 associated with entity identifier 123. Any or all of such enhanced data can be provided to the advertisement delivery service 208. For example, in some cases, a selected or determined most relevant or appropriate enhanced data might be returned (e.g., shoe voted most popular or most comfortable in 2013). In other cases, all relevant enhanced data might be provided to the advertisement delivery service 208 for the advertisement selector 242 or other component to determine enhanced data to provide in association with the advertisement. The enhanced advertisement selector 242, or other component, can then integrate the enhanced data with the advertisement provided by the advertiser to generate an enhanced advertisement copy of the advertisement. The enhanced advertisement can then be provided to the user device 212 (e.g., via the search engine) for presentation to the user. Although described herein as the advertisement delivery service 208 performing or generating the enhanced advertisement, as can be appreciated, another component, such as the search engine, can facilitate such functionality. For instance, the search engine 210 can communicate with the entity repository to obtain enhanced data and generate the enhanced advertisement copy therefrom. Further, as can be appreciated, such enhanced advertisements can be generated in advance. In this regard, enhanced data can be provided to the advertisement delivery service 208 for aggregation with the advertisement.

By way of example, and with reference to FIG. 3, FIG. 3 illustrates an exemplary method 300 of enhancing advertisements, in accordance with an embodiment of the present invention. The method 300 is described in the context of an enhanced advertisement selector, such as enhanced advertisement selector 224 for ease of illustration, but is not limited to being performed in accordance therewith. Initially, as indicated at block 310, a query is received. Such a query may be provided, for example, by a user via a user device. As previously described, the received query may be an altered or annotated version of a query initially provided by a user. At block 312, an advertisement to be presented is selected based on the received query. In this regard, the received query is utilized to identify an advertisement to be presented. Advertisements can be selected in any manner. For example, in some cases, a core advertisement index and one or more vertical advertisement indices may be referenced to identify one or more relevant advertisements. Further, any number or type of factors might be analyzed to select a specific advertisement(s) for presentation. For instance, various advertisement preferences, advertisement bids, and other rules (e.g., demotargeting, geotargeting, etc.) can be used to facilitate advertisement selection.

At block 314, an entity identifier associated with the selected advertisement is recognized. The entity identifier can provide a unique identification of the entity corresponding with the advertisement. In some cases, the entity identifier is stored with the advertisement, or data associated therewith, within an appropriate advertisement index. At block 316, the entity identifier is used to identify supplemental data within an entity repository. Such supplemental data can provide additional information pertaining to the entity. Supplemental data within the entity repository can be identified in various ways. For instance, in some implementations, the entity identifier can be sent to the entity repository, which can then lookup and return supplemental data based on the entity identifier. Subsequently, at block 318, the supplemental data is aggregated with the advertisement to enhance the advertisement. Such supplemental data can be integrated with the original advertisement (advertiser-supplied advertisement) or overlaid over the original advertisement. The enhanced advertisement can then be provided, for example, to the user device, as shown at block 320.

### Enhanced Advertisement Selection Using a Query-Entity Identifier(s)

Returning to FIG. 2, the enhanced advertisement system 200 illustrated in FIG. 2 can be utilized to facilitate enhanced advertisement selection, ranking, and/or richness using a query-entity identifier(s). A query-entity identifier refers to an entity identifier that is assigned or associated with a query. In this regard, an incoming query can be associated with an entity identifier(s) that can be used to improve advertisement selection.

In implementation, upon a search engine 210 receiving a query, such as a query input by a user at the user device 212, the query-entity identifier 250 can identify a query identifier(s) to be associated with the query. Although the query-entity identifier 250 is illustrated as a component of the search engine 210, such functionality might be performed, for instance, by the advertisement delivery service 208 (e.g., query classifier 240). In some embodiments, to identify a query identifier to be associated with a query, the query-entity identifier 250 may communicate with the entity repository 206. The query-entity identifier 250 and/or the entity repository 206 can determine if the query has a correlation to an entity(s) in the entity repository 206. Determining a correlation with an entity(s) can be done in any number of ways. In some cases, the query, or portion thereof, may be compared to the entities in the entity repository 206, such as entity title or entity description. In other cases, the query, or portion thereof, may be compared to entity attributes. Entity attributes can be any attribute associated with the entity that describes, indicates, classifies, summarizes, etc. the entity. For instance, an attribute might describe a class or category of a product.

If an entity is identified as corresponding with the query, the query can be stamped, tagged, or otherwise designated or associated with the entity identifier of the identified entity. By way of example only, assume a query is entered pertaining to restaurant A. Restaurant A can be searched in the entity repository 206 to determine (e.g., lookup) if there is an entity identifier associated with Restaurant A. Assuming entity identifier ABC is associated with Restaurant A, the incoming query can be associated with (e.g., tagged) entity identifier ABC. By way of another example, assume a query is entered that is or includes “SUV.” “SUV” can be searched for in the entity repository 206 to identify any entities having “SUV” as a corresponding attribute thereby enabling multiple advertisements associated with SUV to be identified as relevant. Upon identifying “SUV” as an entity attribute for a particular entity, the entity identifier of that entity can be associated with the query.

In addition, in some embodiments, related entities can also be identified and associated with the query. In some cases, related entities may be indicated in the entity repository 206 as related or linked. As such, upon identifying a first entity as relevant to a query (e.g., based on the entity or an entity attribute), entities indicated as related to or linked to the first entity can be identified within the entity repository 206. In such a case, the query can correspond or be associated with multiple entity identifiers for use in identifying relevant advertisements. By way of example only, assume a query is or includes the name of an actor. In searching the entity repository 206, an entity identifier ABC associated with the actor can be identified. In addition, the entity or entity identifier ABC may also be connected or linked to entities DEF and GHI, each representing a movie in which the actor was a cast member. As such, each of the entity identifiers ABC, DEF, and GHI might be associated with the query for enhanced advertisement selection, ranking, and/or richness.

The entity identifier(s) assigned to a query (i.e., query-entity identifier) can then be used to facilitate advertisement selection, ranking, and/richness. In this regard, the query-entity identifier(s) might be used to identify any matching query identifiers associated with advertisements in the particular advertisement indices being searched. Upon identifying query identifiers in the advertisement index(s) that match the query-entity identifier, the advertisements corresponding with such query identifiers might be designated as relevant to the query and provided to the advertisement selector 242.

Alternatively or additionally, the advertisement selector 242 might use the query-entity identifier to compare with entity identifiers of advertisements initially deemed relevant to the query. As such, when the advertisement selector 242 obtains an advertisement pool of potential advertisements for display, the advertisement selector 242 might compare the query-entity identifier to entity identifiers associated with the advertisements in the advertisement pool. Any matches of the entity identifiers and the query-entity identifier(s) can be used to select particular advertisements to display, rank the order of the advertisements, and/or determine the richness for displaying an advertisement(s).

Although the above description refers to using related entities and/or entities identified using entity attributes in relation to a query, as can be appreciated, other implementations might additionally or alternatively be used to enhance advertisement selection. In this regard, upon receiving an advertisement, for example, from an advertiser, the advertisement can be associated with an entity identifier (e.g., via the advertisement manager 204, the entity repository 206, or the advertisement delivery service 208). Upon identifying an entity identifier associated with the advertisement, related entity identifiers and/or entity attributes can also be associated with the advertisement and stored as such in the appropriate advertisement index.

By way of example, and with reference to FIG. 4, FIG. 4 illustrates an exemplary method 400 of enhancing advertisement selection using a query-entity identifier(s), in accordance with an embodiment of the present invention. The method 400 is described in the context of an enhanced advertisement selector, such as enhanced advertisement selector 224 of FIG. 2 for ease of illustration, but is not limited to being performed in accordance therewith. Initially, as indicated at block 410, a query is received. Such a query may be provided, for example, by a user via a user device. As previously described, the received query may be an altered or annotated version of a query initially provided by a user. At block 412, an entity identifier associated with the query is obtained. Such an entity identifier associated with the query can be obtained in any manner. For example, in one embodiment, the query is provided to an entity repository to identify and return an entity associated with the query. In some cases, an entity identifier associated with a query is an identifier of a related entity. In this way, upon identifying an entity corresponding with the query, entities related thereto (e.g., as indicated in an entity repository) can be identified and associated with the query. At block 414, the entity identifier associated with the query is used to select an advertisement for display, rank an advertisement for display, or determine richness for an advertisement to be displayed. By way of example only, the entity identifier associated with the query can be compared and/or matched to entity identifiers associated with advertisements to enhance advertisement selection, ranking, and/or richness.

### Enhanced Advertisement Selection Using Entity Preferences

Returning again to FIG. 2, the enhanced advertisement system 200 illustrated in FIG. 2 can be utilized to facilitate enhanced advertisement selection, ranking, and/or richness using entity preferences and/or entity bids. As previously described, an entity preference is a preference for an advertisement(s) to be displayed when a particular entity is associated with a search result or utilization by a user. In this regard, whenever a particular entity is provided as a search result or associated with a search result or a user utilizes the particular entity (e.g., to place a voicecall), the advertiser would like their advertisement displayed (or one of their advertisements displayed). Such an entity preference and/or entity bid can be input by an advertiser, for example, via a user interface of the advertisement manager 204 of FIG. 2. An entity preference can be indicated in any number of manners, such as, for example, a title of the entity, a selection of an entity or entity identifier, or the like.

In implementation, upon a search engine 210 receiving a query, such as a query input by a user at the user device 212, the search engine 210 can generate a set of search results that are deemed relevant or related to the search query. In selecting, ranking, or determining richness of an advertisement(s) for display, the enhanced advertisement selector 224 (e.g., the advertisement selector 242) can recognize one or more entity identifiers associated with search results. Such entity identifiers can be determined by the enhanced advertisement selector 224 or otherwise obtained, for instance, from the search engine 210 or the entity repository 206. Such entity identifiers associated with the search results can be used to search the advertisement index(s) for corresponding advertisements. Alternatively or additionally, upon obtaining a pool of relevant advertisements, the advertisement selector 242 can utilize the entity identifiers associated with the search results to select advertisements for display, rank advertisements to be displayed, and/or determine richness for an advertisement to be displayed. In this way, an entity bid associated with an advertisement deemed relevant can be used to analyze selection, ranking, or richness of the advertisement. For example, assume an advertiser indicates or identifies a preference for entity A (e.g., user selection or user input of an entity or entity identifier) and provides an entity bid of $1.00 for display of an advertisement when entity A is associated with a search result identified as related to the search query. In such a case, when a search result is to be presented that is associated with entity A, a $1.00 bid is applied in the advertisement auction for the advertisement and such a bid can be used for selecting, ranking, and/or displaying the advertisement. As another example, assume an advertiser indicates or identifies a preference for entity B, for example, by selection or input of an entity or entity identifier, and provides an entity bid of $1.00 for display of an advertisement when entity B is utilized. Thereafter, a user selects or inputs a phone number that can be used via Skype® (e.g., enter a number to place a call). In such a case, the number can be looked up in an entity repository to identify entity B associated with the number. Upon identifying the entity B, a $1.00 bid can be applied in the advertisement auction for the advertisement so that the advertisement might be provided to the user in association with the user placing the call.

By way of example, and with reference to FIG. 5, FIG. 5 illustrates a first exemplary method 500 of enhancing advertisement selection using an entity preference, in accordance with an embodiment of the present invention. The method 500 is described in the context of an advertisement delivery service, such as advertisement delivery service 208 of FIG. 2 for ease of illustration, but is not limited to being performed in accordance therewith. Initially, as indicated at block 510, an indication of an entity preference and a corresponding entity bid in association with an advertisement is received. An entity preference, an entity bid, and/or an advertisement may be input, selected, or provided by an advertiser via a user interface. At block 512, the entity preference and the entity bid are stored in association with the advertisement, or data associated therewith. At block 514, a query is received. Such a query may be provided, for example, by a user via a user device. As previously described, the received query may be an altered or annotated version of a query initially provided by a user. At block 516, it is determined that at least one search result for the query is associated with the entity preference. Based on the at least one search result being associated with the entity preference, at block 518, the entity bid is used in association with the advertisement to participate in an advertisement auction. Such utilization can result in enhancing advertisement selection, advertisement ranking, and/or advertisement richness.

Turning now to FIG. 6, FIG. 6 illustrates a second exemplary method 600 of enhancing advertisement selection using an entity preference, in accordance with an embodiment of the present invention. The method 600 is described in the context of an advertiser device, such as advertiser device 202 of FIG. 2 for ease of illustration, but is not limited to being performed in accordance therewith. Initially, as indicated at block 610, an indication of an entity preference and a corresponding entity bid in association with an advertisement is received. An entity preference, an entity bid, and/or an advertisement may be input, selected, or provided by an advertiser via a user interface. Thereafter, at block 612, the entity preference and corresponding entity bid in association with the advertisement are provided to an advertisement delivery service for use in an advertisement auction when at least one search result for a query is associated with the entity preference. In this way, an advertiser can elect or make an effort to have an advertisement displayed when a particular entity is designated as relevant via the search engine. As can be appreciated, an advertiser might select a particular entity for any number of reasons. In one example, an advertiser might select an entity associated with the advertiser. For example, assume that an advertiser is a representative of Company A. As such, the advertiser may bid on the entity of Company A such that a Company A advertisement is more likely to appear when a search result is associated with Company A. In another example, an advertiser might select an entity that is of interest or related to the advertiser. For instance, assume that a restaurant is located near a theme park. As such, the advertiser for the restaurant may bid on the entity of the theme park such that a restaurant advertisement is more likely to appear when a search result is associated with the theme park. In this regard, rather than the restaurant advertiser having to speculate as to various keywords that might be relevant to the theme park, the advertiser can simply indicate an entity preference.

Turning now to FIG. 7, FIG. 7 illustrates a third exemplary method 700 of enhancing advertisement selection using an entity preference, in accordance with an embodiment of the present invention. The method 700 is described in the context of a user device, such as user device 212 of FIG. 2 for ease of illustration, but is not limited to being performed in accordance therewith. Initially, as indicated at block 710, a search query is provided. Such a search query can be provided via a website associated with a search engine. In response to submitting the search query, as indicated at block 712, a set of search results is received along with an advertisement that is related to at least one of the search results. Such an advertisement can be selected for display based on the association between the advertisement and the at least one search result. Thereafter, at block 714, the set of search results and advertisement are caused to be displayed.

Exemplary methods described herein can be described in the general context of computer executable instructions. Generally, computer executable instructions can include routines, programs, objects, components, data structures, procedures, modules, functions, and the like that perform particular functions or implement particular abstract data types. The methods can also be practiced in a distributed computing environment where functions are performed by remote processing devices that are linked through a communication network or a communication cloud. In a distributed computing environment, computer executable instructions may be located both in local and remote computer storage media, including memory storage devices.

The exemplary methods are illustrated as a collection of blocks in a logical flow graph representing a sequence of operations that can be implemented in hardware, software, firmware, or a combination thereof. The order in which the methods are described is not intended to be construed as a limitation, and any number of the described method blocks can be combined in any order to implement the methods, or alternate methods. Additionally, individual operations may be omitted from the methods without departing from the spirit and scope of the subject matter described herein. In the context of software, the blocks represent computer instructions that, when executed by one or more processors, perform the recited operations.

Embodiments of the present invention have been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure. It will be understood that certain features and subcombinations are of utility and may be employed without reference to other features and subcombinations. This is contemplated by and is within the scope of the claims.

What is claimed is:

1. One or more computer-storage media storing computer-useable instructions that, when executed by a computing device, perform a method for facilitating enhanced advertisement display, comprising:
receiving an indication of an entity preference and a corresponding entity bid in association with an advertisement; and
providing the entity preference and the corresponding entity bid associated with the advertisement for use in an advertisement auction, wherein when at least one search result for a query is associated with the entity preference, the entity bid is used to participate in the advertisement auction.

2. The computer-storage media of claim 1, wherein the indication of the entity preference and the entity bid is provided by a user via a user interface for managing advertisements.

3. The computer-storage media of claim 2, wherein the advertisement is provided by the user via a user interface for managing advertisements.

4. The computer-storage media of claim 1, wherein the entity preference is an entity identifier that uniquely identifies an entity.

5. The computer-storage media of claim 1, wherein the indication of the entity preference comprises an indication of a person, an indication of a place, or an indication of a thing.

6. One or more computer-storage media storing computer-useable instructions that, when executed by a computing device, perform a method for facilitating enhanced advertisement display, comprising:
recognizing an entity identifier uniquely identifying an entity associated with an advertisement selected for presentation in response to a received search query;
using the entity identifier to identify supplemental data within an entity repository that is associated with the entity identifier; and
providing an enhanced advertisement that includes the advertisement and the supplemental data.

7. The computer-storage media of claim 6, wherein the entity identifier is stored in association with the advertisement in an advertisement index.

8. The computer-storage media of claim 7, wherein the entity identifier was determined to be associated with the advertisement based on input provided by an advertiser.

9. The computer-storage media of claim 6, wherein the entity identifier is transmitted to the entity repository to lookup the supplemental data associated with the entity identifier.

10. The computer-storage media of claim 6 further comprising selecting the advertisement for presentation in response to the received search query.

11. The computer-storage media of claim 6, wherein the supplemental data comprises rating information, award information, announcement information, hours of operation information, a business or product highlight information, certificate information, standards information, or a combination thereof.

12. The computer-storage media of claim 6, wherein the entity repository includes entity data associated with a plurality of entities based on one or more webcrawlers identifying the entity data.

13. The computer-storage media of claim 6 further comprising generating the enhanced advertisement by integrating the advertisement and the supplemental data.

14. A system for facilitating enhanced advertisement display, the system comprising:
a core advertisement index including a plurality of core advertisements available for display based on one or more corresponding keywords for each core advertisement;
a plurality of vertical advertisement indices, wherein each vertical advertisement index includes a plurality of item advertisements associated with a vertical segment that are available for display based on one or more corresponding filters for each item advertisement; and
an advertisement selecting component that obtains core advertisements relevant to a search query and item advertisements relevant to a search query and utilizes keyword bids associated with the core advertisements and autotarget bids associated with the item advertisements to select one or more advertisements from among the obtained core advertisements and index advertisements to present in response to the search query.

15. The system of claim 14, wherein the plurality of item advertisements associated with the vertical segment are provided by one or more advertisers via one or more data feeds.

16. The system of claim 14, wherein the core advertisements relevant to the search query were obtained based on a match between the search query and keywords associated with the core advertisements.

17. The system of claim 14, wherein the item advertisements relevant to the search query were obtained based on a match between an entity identifier associated with the search query and an entity identifier associated with the item advertisements.

18. The system of claim 14, wherein the autotarget bids comprise a monetary value to be paid for an item advertisement being displayed or selected when the item advertisement corresponds with at least one filter identified by the advertiser.

19. The system of claim 18, wherein the at least one filter indicates a brand or a product type.

20. The system of claim 14, wherein the advertisement selecting component uses at least one of demotargeting rules, geotargeting rules, or user preference rules to select one or more advertisements to present in response to the search query.
